(19) United States
(12) Patent Application Publication
(10) Pub. No.: US 2023/0096482 A1
(43) Pub. Date: Mar. 30, 2023

(54) PRIORITIZED ACCESS FOR PPDU RETRANSMISSIONS AFTER A COLLISION

(71) Applicants: Laurent Cariou, Milizac (FR); Thomas J. Kenney, Portland, OR (US)

(72) Inventors: Laurent Cariou, Milizac (FR); Thomas J. Kenney, Portland, OR (US)

(21) Appl. No.: 18/073,756

(22) Filed: Dec. 2, 2022

(51) Int. Cl. H04W 74/08

(52) U.S. Cl. CPC H04W 74/085; H04W 74/0875

(57) ABSTRACT

Embodiments disclosed herein provide favored channel access for STAs whose transmissions have failed or collided. After a first collision or transmission failure, a STA receives prioritized access in order to re-transmit a PPDU. If an initial transmission of the PPDU is unsuccessful (e.g., the initial transmission fails or if the PPDU collides with another transmission), for retransmission of the PPDU, the STA may update the EDCA parameters to EDCA parameters for prioritized access, may determine a backoff for accessing the wireless medium, and may retransmit the PPDU based on the EDCA parameters for prioritized access (i.e., using the updated EDCA parameters). The EDCA parameters for prioritized access may be configured to give the STA a higher probability of accessing the wireless medium for a PPDU retransmission than use of the initial EDCA parameters.

### TECHNICAL FIELD

Embodiments pertain to wireless communications. Some embodiments relate wireless local area networks (WLANs) that operate in accordance with the IEEE 802.11 standards. Some embodiments relate to IEEE 802.11be Extremely High Throughput (EHT) (i.e., the IEEE P802.11-Task Group BE EHT) (Wi-Fi 7). Some embodiments relate to next generation Wi-Fi (Wi-Fi 8).

### BACKGROUND

Previous generations of WLANs operate largely using enhanced distributed channel access (EDCA) channel access. The mechanism has many advantages the most beneficial being that the mechanism always provides access to all devices while minimizing the collisions. However, the maximum latency bound can be very high in some situations. As latency-sensitive applications are becoming more and more important, there is a need to reduce such latency bound.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6 illustrates an enhanced distributed channel access (EDCA) backoff procedure for two access categories, in accordance with some embodiments.

FIG. 7 is a procedure performed by processing circuitry of a non-access point station (STA) for transmission of a physical layer protocol data unit (PPDU) to an access point station (AP), in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments disclosed herein provide adaptations to the EDCA rules in order to favor channel access for STAs whose transmissions have failed or collided. This helps to reduce the maximum delay bound and minimize any additionally penalty that a STA may incur if there is a collision or transmission failure. In these embodiments, after a first collision or transmission failure, a STA receives prioritized access in order to re-transmit a PPDU. These embodiments are described in more detail below.

Some embodiments are directed to a non-access point station (STA). In these embodiments, for transmission of a physical layer protocol data unit (PPDU) to an access point station (AP), the STA may perform an enhanced distributed channel access (EDCA) process to access a wireless medium for an initial transmission of the PPDU based on initial EDCA parameters. In these embodiments, the EDCA process may comprise determining a random backoff for accessing the medium based on an access category of the PPDU. In these embodiments, if the initial transmission of the PPDU is unsuccessful (e.g., the initial transmission fails or if the PPDU collides with another transmission), for retransmission of the PPDU, the STA may update the EDCA parameters to EDCA parameters for prioritized access, may determine a backoff for accessing the wireless medium, and may retransmit the PPDU based on the EDCA parameters for prioritized access (i.e., using the updated EDCA parameters). In these embodiments, the EDCA parameters for prioritized access may be configured to give the STA a higher probability of accessing the wireless medium for a PPDU retransmission than use of the initial EDCA parameters. These embodiments are described in more detail below.

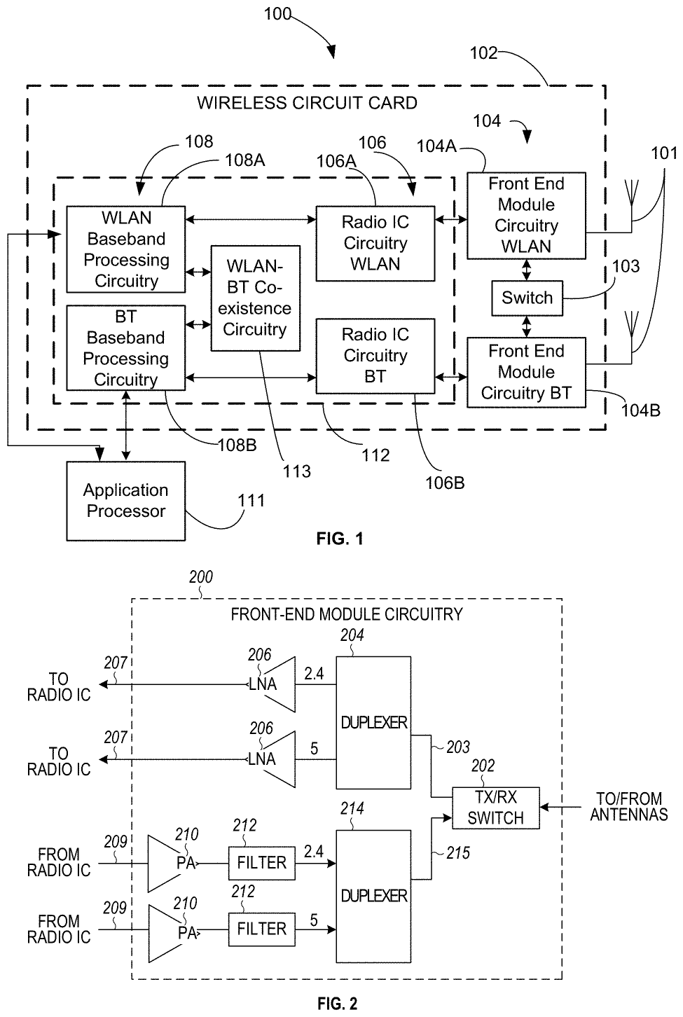

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, and/or IEEE P802.11be standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

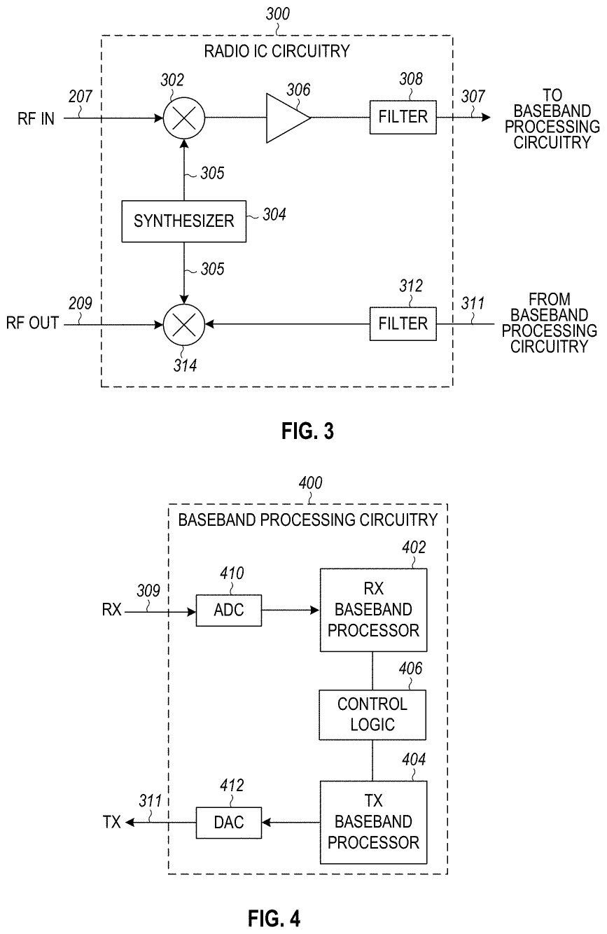

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

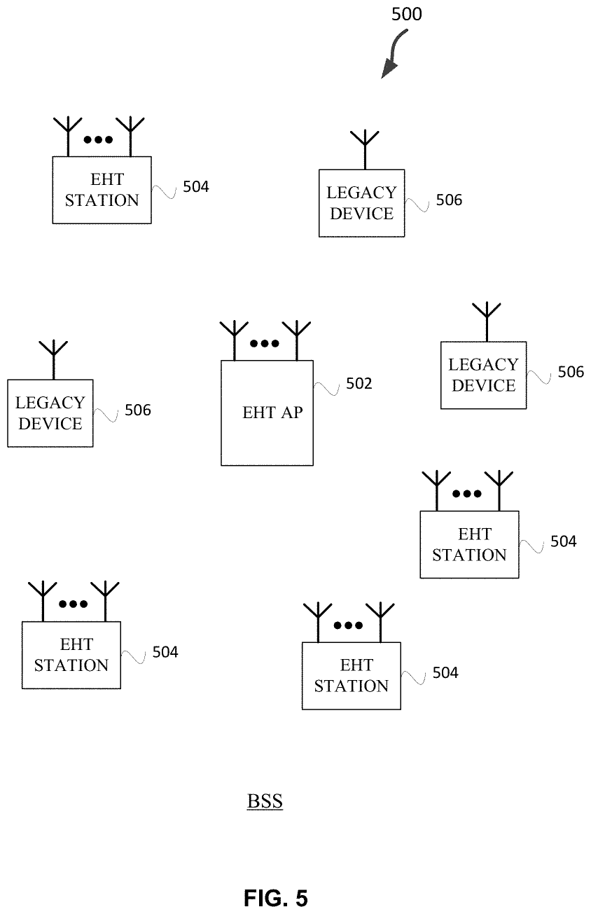

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 may be EHT STAs. In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502. IEEE P802.11be/D2.0, May 2022 is incorporated herein by reference.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be different types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a master station which may be arranged to contend for a wireless medium (e.g., during a contention period) to receive exclusive control of the medium for an control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy stations 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement.

In some embodiments station 504 may be a “group owner” (GO) for peer-to-peer modes of operation. A wireless device may be a Station 502 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to access point 502 and/or station 504 as well as legacy devices 506.

In some embodiments, a AP STA may refer to a AP 502 and a STAs 504 that is operating a APs 502. In some embodiments, when an STA 504 is not operating as a AP, it may be referred to as a non-AP STA or non-AP. In some embodiments, STA 504 may be referred to as either a AP STA or a non-AP.

In some embodiments, a physical layer protocol data unit may be a physical layer conformance procedure (PLCP) protocol data unit (PPDU). In some embodiments, the AP and STAs may communicate in accordance with one of the IEEE 802.11 standards. IEEE Std 802.11-2020 is incorporated herein by reference. IEEE P802.11-REVmd/D2.4, August 2019, and IEEE draft specification IEEE P802.11ax/D5.0, October 2019 are incorporated herein by reference in their entireties. In some embodiments, the AP and STAs may be directional multi-gigabit (DMG) STAs or enhanced DMG (EDMG) STAs configured to communicate in accordance with IEEE 802.11ad standard or IEEE draft specification IEEE P802.11ay, February 2019, which is incorporated herein by reference.

In some embodiments, the mobile device may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The antennas may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the mobile device is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

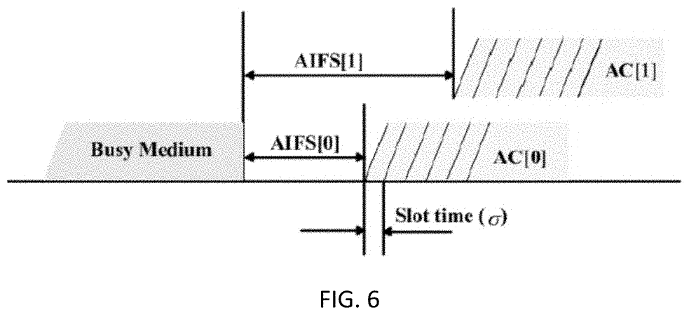

FIG. 6 illustrates an enhanced distributed channel access (EDCA) backoff procedure for two access categories, in accordance with some embodiments. EDCA relies on exponential backoff, which increases the backoff time/range of a STA by a factor of up to two every time there is a collision (i.e., when two STAs end their backoff at the same time and their transmission collide). This is meant to reduce the chances that these two STAs will again collide during their next attempt to access the network. When a STA selects a first backoff and collides, not only is that STA unlucky in the collision, and therefore not able to transmit its payload, but it will be basically punished by being forced to draw a new backoff time which will be statistically larger than the first, causing an even longer wait time before being able to attempt another access of the medium. Thus, this an additional penalty for STAs that comply with the exponential backoff mechanism.

The EDCA quality-of-service (QOS) mechanism attempts to work around this by reducing the exponential backoff for high access categories, which get doubled only once. Even in those cases, those STAs are likewise being more or less penalized when their transmissions fail or collide.

Some embodiments disclosed herein provide some adaptations to the EDCA rules in order to actually favor channel access for those who failed or collided, to reduce the maximum delay bound and minimize any additionally penalty a STA will incur if there is a collision. In these embodiments, after a first collision, a STA would receive prioritized access in order to re-transmit its packet. For this discussion, the transmission process is considered in two steps. The first step corresponds to the first transmission of a PPDU and the second step corresponds to a retransmission, if any.

For the first step, the regular EDCA process is used, which means that the STA will draw a random backoff between 0 and CWmin depending on its access category and follow the regular EDCA process to access the medium and transmit. If transmission of the PPDU is successful, the STA can restart the process for a subsequent payload to transmit. If it fails or collides, the STA will move to step two. For the second step, the embodiments disclosed herein provide several options.

Option One: In these embodiments, EDCA parameters for prioritized access (e.g., a 5^{th} access category) are defined which has highly prioritized default parameters (e.g., CWmin, AIFSN) and whose parameters are controlled and advertised by the AP in its beacons in order to update them depending on the load and the collision rates of retransmissions. In these embodiments, when entering the second step, a STA that has collided in step one with one of the four existing access categories, can update its EDCA parameters (e.g., CWmin, AIFSN, TxOP Duration, etc.) to the values of the 5^{th} access category before drawing a new backoff number specifically for the retransmission. This will allow the retransmission to have better chance of accessing the medium. Once the PPDU is successfully retransmitted, the STA will go back to step one. If transmission of the PPDU fails again, the STA will stay in step two and, depending on the EDCA parameters of the 5^{th} AC, it may double the backoff or not change the backoff.

Option Two: These embodiments are based on option on, except that instead of defining a new 5^{th} AC, access to the AC-VO (highest priority AC) is allowed in step two for a STA that used another AC in the first step.

Option Three: In these embodiments, a STA whose initial transmission failed in step one is allowed to preempt the channel to retransmit.

In these channel preemption embodiments, a fixed time (e.g., lower than SIFS, maybe 8 or 12 us) after the start of a contention period, the STA will be allowed to transmit a reservation signal. This reservation signal may be just a very short 4 or 8 us STF signal in order to trigger energy or potentially longer to include the LTF and a L-SIG in order to trigger symbol detection on other STAs participating in the same contention period, so that those STAs will not be able to participate in this contention period (as the STAs will consider the medium as busy and will likely have to wait for EIFS before re-counting down). If two or more STAs are allowed to preempt the medium, all of them will send the reservation signal, that will overlap.

In these channel preemption embodiments, once the reservation signal is sent, the STAs that sent a reservation signal will be the only ones that can still decrement backoff and contend for the medium. There should not be a lot of STAs that are in this situation, but there could be more than one. In these embodiments, a specific set of contention parameters are used to reduce the chances of collisions between these STAs while keeping the backoff very short. In these embodiments, a new contention mechanism may be used or existing EDCA mechanisms as in option one (EDCA parameters for prioritized access) or option two (using AC-VO parameters). Option one, which uses a dedicated set of EDCA parameters for prioritized access, may be better suited in this situation allowing the AP is able to control and change the EDCA parameters of the AC-VO and of the EDCA parameters for prioritized access, independently.

In some of these channel preemption embodiments, if a collision is detected at the AP, then the AP may take control of the media and signal a collision. The AP would know this a collision for this mode since the reservation signal was received prior to an expected SIFS time and that it failed the STF and or SIG detection. Then the STAs that receive the notice from the AP that a collision occurred would select parameters based on a method outlined above for EDCA.

In some embodiments, additional rules may be defined which allow STAs to use prioritized access only for packets from a specific AC or TID (limit to AC-VO, VI and BE for instance, or only AC-VO for instance), or for specific traffic identified as such by an SCS request. In some embodiments, additional rules may be defined which force the transmission rate of the retransmission to be reduced or fix this transmission rate. In some embodiments, additional rules may be defined which prevent STAs from being intentionally aggressive in rate selection for the first transmission, knowing that it will get prioritized access for the retransmission, by limiting the amount/ratio of retransmissions in a particular time period.

*Some embodiments are directed to a non-access point station (STA). In these embodiments, for transmission of a physical layer protocol data unit (PPDU) to an access point station (AP), the STA may perform an enhanced distributed channel access (EDCA) process to access a wireless medium for an initial transmission of the PPDU based on initial EDCA parameters. In these embodiments, the EDCA process may comprise determining a random backoff for accessing the medium based on an access category of the PPDU. In these embodiments, if the initial transmission of the PPDU is unsuccessful (e.g., the initial transmission fails or if the PPDU collides with another transmission), for retransmission of the PPDU, the STA may update the EDCA parameters to EDCA parameters for prioritized access, may determine a backoff for accessing the wireless medium, and may retransmit the PPDU based on the EDCA parameters for prioritized access (i.e., using the updated EDCA parameters). In these embodiments, the EDCA parameters for prioritized access may be configured to give the STA a higher probability of accessing the wireless medium for a PPDU retransmission than use of the initial EDCA parameters.

In these embodiments, the initial transmission of the PPDU may be unsuccessful, for example if the initial transmission fails or if the PPDU collides with another transmission. In these embodiments, the EDCA parameters for prioritized access may give the STA an improved chance to access the medium for a PPDU retransmission. Accordingly, after a collision or transmission failure, the STA may have prioritized access. In these embodiments, the EDCA process to access a wireless medium for an initial transmission of the PPDU based on the initial EDCA parameters may be performed in accordance with an IEEE 802.11 standard (i.e., a conventional or standard EDCA process) using an exponential backoff, which increases the backoff time by a factor of up to two every time there is a collision.

In some embodiments, for the initial transmission of the PPDU, the random backoff is determined to be between zero and a minimum contention window (CWmin), the CWmin based on the access category of the PPDU. In these embodiments, the EDCA process to access the medium for the initial transmission of the PPDU may be performed in accordance with one of four legacy access categories comprising, in order from highest to lowest priority: Voice (AC_VO), Video (AC_VI), Best Effort (AC_BE) and Background (AC_BK) access categories. In these embodiments, to provide the prioritized access, the EDCA parameters for the prioritized access may have lower values for one or more of the CWmin and an arbitration inter-frame space number (AIFSN) than any of the four legacy access categories.

In some embodiments, the EDCA parameters for the prioritized access may have a lower value for the maximum contention window size (CWmax). In these embodiments, a shorter AIFS period provides a PPDU with a higher probability of being transmitted with reduced latency. The backoff based on the EDCA parameters for prioritized access may be random or non-random. In these embodiments, the EDCA process to access the medium for the initial transmission of the PPDU may be in accordance with one of the legacy access categories in accordance with the IEEE 802.11-2020.

In some embodiments, the EDCA parameters for prioritized access may comprise EDCA parameters for a fifth access category. The fifth access category may be a higher priority access category than the voice access category.

In some embodiments, the STA may decode one of a beacon frame, a management frame and a probe response frame from the AP to receive the EDCA parameters for prioritized access, although the scope of the embodiments is not limited in this respect.

In some embodiments, the EDCA parameters for prioritized access may comprise EDCA parameters for the voice access category when the EDCA process to access the medium for the initial transmission of the PPDU utilized EDCA parameters for a lower priority access category. In some of these embodiments, the EDCA parameters for the voice access category may be used for retransmissions after a collision or transmission failure.

In some embodiments, for retransmission of the PPDU, the STA may be configured to preempt the wireless medium (i.e., the channel) by transmission of a reservation signal less than a SIFS after a start of a contention period. In these embodiments, after transmission of the reservation signal, the STA may contend for the medium using EDCA parameters for preemption. In these embodiments, the EDCA parameters for preemption may comprise a shortened backoff that is less that a backoff for the voice access category. In some embodiments, the EDCA parameters for preemption may be the same as the EDCA parameters that are used for prioritized access discussed above, although the scope of the embodiments is not limited in this respect.

In some embodiments, the reservation signal may comprise only a preamble comprising a shortened (e.g., 4 us or Bus) training field (e.g., a shorter short training field (STF)) signal to trigger symbol detection by other STAs. In some embodiments, the preamble may also comprise a long-training field (LTF) and a legacy signal field (L-SIG), although the scope of the embodiments is not limited in this respect. In these embodiments, the preamble may be configured to trigger symbol detection by other STAs to inhibit those STAs from participating in this contention period. These embodiments that preempt the wireless medium force other STAs not to contend for the medium by use of the reservation signal.

In some embodiments, when the initial transmission of the PPDU is successful or when the retransmission of the PPDU is successful, for subsequent PPDU transmissions the STA may be configured to switch back use of the initial EDCA parameters (i.e., use the EDCA parameters for the AC of the PPDU). In these embodiments, when the retransmission of the PPDU is unsuccessful using the EDCA parameters for prioritized access, the STA may continue to utilize the EDCA parameters for prioritized access for subsequent attempted retransmissions of the PPDU.

In some embodiments, for each subsequent retransmission failure, the STA may use EDCA parameters that give the STA an even higher probability of accessing the medium, although this is not a requirement. In some embodiments, the STA may refrain from utilizing the EDCA parameters for prioritized access when a collision has not occurred. In some embodiments, the STA may refrain from utilizing the EDCA parameters for prioritized access for an initial transmission of a PPDU. In some embodiments, the STA may be configured to refrain from contending for the medium using the EDCA parameters for prioritized access for retransmission of PPDUs having one or more predetermined access categories (i.e., AC_BE and AC_BK), although the scope of the embodiments is not limited in this respect. In some embodiments, the STA may be configured to reduce a transmission rate for retransmission of the PPDU using the EDCA parameters for prioritized access.

Some embodiments are directed to a non-transitory computer-readable storage medium that stores instructions for execution by processing circuitry of a non-access point station (STA). In these embodiments, for transmission of a physical layer protocol data unit (PPDU) to an access point station (AP), the processing circuitry may configure the STA to perform an enhanced distributed channel access (EDCA) process to access a wireless medium for an initial transmission of the PPDU based on initial EDCA parameters. In these embodiments, the EDCA process may comprise determining a random backoff for accessing the medium based on an access category of the PPDU. In these embodiments, if the initial transmission of the PPDU is unsuccessful, for retransmission of the PPDU, the processing circuitry may update the EDCA parameters to EDCA parameters for prioritized access, may determine a backoff for accessing the wireless medium, and may configure the STA to retransmit the PPDU based on the EDCA parameters for prioritized access (i.e., using the updated EDCA parameters). In these embodiments, the EDCA parameters for prioritized access may be configured to give the STA a higher probability of accessing the wireless medium for a PPDU retransmission than use of the initial EDCA parameters.

Some embodiments are directed to a method performed by processing circuitry of a non-access point station (STA) for transmission of a physical layer protocol data unit (PPDU) to an access point station (AP). In these embodiments, the method may include performing an enhanced distributed channel access (EDCA) process to access a wireless medium for an initial transmission of the PPDU based on initial EDCA parameters. In these embodiments, the EDCA process may comprise determining a random backoff for accessing the medium based on an access category of the PPDU. In these embodiments, if the initial transmission of the PPDU is unsuccessful, for retransmission of the PPDU, the method may also include updating the EDCA parameters to EDCA parameters for prioritized access, determining a backoff for accessing the wireless medium, and retransmitting the PPDU based on the EDCA parameters for prioritized access (i.e., using the updated EDCA parameters). In these embodiments, the EDCA parameters for prioritized access are configured to give the STA a higher probability of accessing the wireless medium for a PPDU retransmission than use of the initial EDCA parameters.

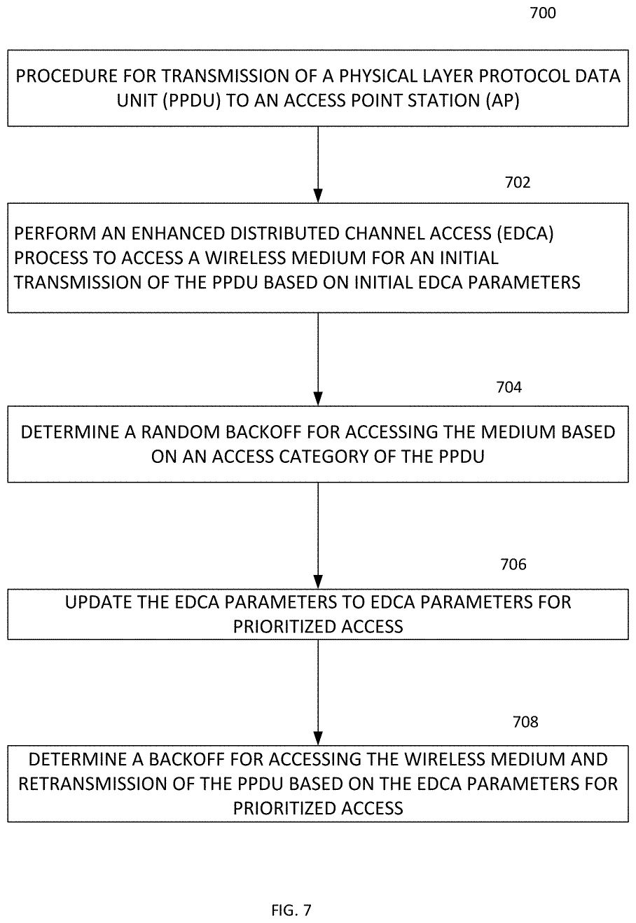

FIG. 7 is a procedure 700 performed by processing circuitry of a non-access point station (STA) for transmission of a physical layer protocol data unit (PPDU) to an access point station (AP), in accordance with some embodiments. Operation 702 comprises performing an enhanced distributed channel access (EDCA) process to access a wireless medium for an initial transmission of the PPDU based on initial EDCA parameters. Operation 704 comprises determining a random backoff for accessing the medium based on an access category of the PPDU.

If the initial transmission of the PPDU is unsuccessful, operations 706 and 708 may be performed for retransmission of the PPDU. Operation 706 comprises updating the EDCA parameters to EDCA parameters for prioritized access. Operation 708 comprises determining a backoff for accessing the wireless medium and retransmission of the PPDU based on the EDCA parameters for prioritized access using the updated EDCA parameters. In these embodiments, the EDCA parameters for prioritized access are configured to give the STA a higher probability of accessing the wireless medium for a PPDU retransmission than use of the initial EDCA parameters.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a non-access point station (STA), the apparatus comprising: processing circuitry; and memory,
wherein for transmission of a physical layer protocol data unit (PPDU) to an access point station (AP), the processing circuitry is to configure the STA to:
perform an enhanced distributed channel access (EDCA) process to access a wireless medium for an initial transmission of the PPDU based on initial EDCA parameters, the EDCA process comprising determining a random backoff for accessing the medium based on an access category of the PPDU;
wherein if the initial transmission of the PPDU is unsuccessful, for retransmission of the PPDU, the processing circuitry is configured to:
update the EDCA parameters to EDCA parameters for prioritized access; and
determine a backoff for accessing the wireless medium and retransmission of the PPDU based on the EDCA parameters for prioritized access,
wherein the EDCA parameters for prioritized access are configured to give the STA a higher probability of accessing the wireless medium for a PPDU retransmission than use of the initial EDCA parameters.

2. The apparatus of claim 1, wherein for the initial transmission of the PPDU, the random backoff is determined to be between zero and a minimum contention window (CWmin), the CWmin based on the access category of the PPDU,
wherein the EDCA process to access the medium for the initial transmission of the PPDU is performed in accordance with one of four access categories comprising, in order from highest to lowest priority: Voice (AC_VO), Video (AC_VI), Best Effort (AC_BE) and Background (AC_BK) access categories, and
wherein to provide the prioritized access, the EDCA parameters for the prioritized access have lower values for one or more of the CWmin and an arbitration inter-frame space number (AIFSN) than the four access categories.

3. The apparatus of claim 2, wherein the EDCA parameters for prioritized access comprise EDCA parameters for a fifth access category, the fifth access category being a higher priority access category than the voice access category.

4. The apparatus of claim 3, wherein the processing circuitry is configured to decode one of a beacon frame, a management frame and a probe response frame from the AP to receive the EDCA parameters for prioritized access.

5. The apparatus of claim 2, wherein the EDCA parameters for prioritized access comprise EDCA parameters for the voice access category when the EDCA process to access the medium for the initial transmission of the PPDU utilized EDCA parameters for a lower priority access category.

6. The apparatus of claim 2, wherein for retransmission of the PPDU, the STA is configured to preempt the wireless medium by transmission of a reservation signal less than a SIFS after a start of a contention period,
wherein after transmission of the reservation signal, the processing circuitry is to configure the STA to contend for the medium using EDCA parameters for preemption, wherein the EDCA parameters for preemption comprise a shortened backoff, the shortened backoff being less that a backoff for the voice access category.

7. The apparatus of claim 6, wherein the reservation signal comprises only a preamble comprising a shortened training field signal to trigger symbol detection by other STAs.

8. The apparatus of claim 2, wherein when the initial transmission of the PPDU is successful or when the retransmission of the PPDU is successful, for subsequent PPDU transmissions the processing circuitry is configured to switch back use of the initial EDCA parameters, and
wherein when the retransmission of the PPDU is unsuccessful using the EDCA parameters for prioritized access, the processing circuitry is configured to utilize the EDCA parameters for prioritized access for subsequent retransmissions of the PPDU.

9. The apparatus of claim 8, wherein the processing circuitry is to configure the STA to:
refrain from utilizing the EDCA parameters for prioritized access when a collision has not occurred; and
refrain from utilizing the EDCA parameters for prioritized access for an initial transmission of a PPDU.

10. The apparatus of claim 9, wherein the processing circuitry is configured to reduce a transmission rate for retransmission of the PPDU using the EDCA parameters for prioritized access.

11. A non-transitory computer-readable storage medium that stores instructions for execution by processing circuitry of a non-access point station (STA), wherein for transmission of a physical layer protocol data unit (PPDU) to an access point station (AP), the processing circuitry is to configure the STA to:
perform an enhanced distributed channel access (EDCA) process to access a wireless medium for an initial transmission of the PPDU based on initial EDCA parameters, the EDCA process comprising determining a random backoff for accessing the medium based on an access category of the PPDU;
wherein if the initial transmission of the PPDU is unsuccessful, for retransmission of the PPDU, the processing circuitry is configured to:
update the EDCA parameters to EDCA parameters for prioritized access; and
determine a backoff for accessing the wireless medium and retransmission of the PPDU based on the EDCA parameters for prioritized access,
wherein the EDCA parameters for prioritized access are configured to give the STA a higher probability of accessing the wireless medium for a PPDU retransmission than use of the initial EDCA parameters.

12. The non-transitory computer-readable storage medium of claim 11, wherein for the initial transmission of the PPDU, the random backoff is determined to be between zero and a minimum contention window (CWmin), the CWmin based on the access category of the PPDU,
wherein the EDCA process to access the medium for the initial transmission of the PPDU is performed in accordance with one of four access categories comprising, in order from highest to lowest priority: Voice (AC_VO), Video (AC_VI), Best Effort (AC_BE) and Background (AC_BK) access categories, and
wherein to provide the prioritized access, the EDCA parameters for the prioritized access have lower values for one or more of the CWmin and an arbitration inter-frame space number (AIFSN) than the four access categories.

13. The non-transitory computer-readable storage medium of claim 12, wherein the EDCA parameters for prioritized access comprise EDCA parameters for a fifth access category, the fifth access category being a higher priority access category than the voice access category.

14. The non-transitory computer-readable storage medium of claim 13, wherein the processing circuitry is configured to decode one of a beacon frame, a management frame and a probe response frame from the AP to receive the EDCA parameters for prioritized access.

15. The non-transitory computer-readable storage medium of claim 12, wherein the EDCA parameters for prioritized access comprise EDCA parameters for the voice access category when the EDCA process to access the medium for the initial transmission of the PPDU utilized EDCA parameters for a lower priority access category.

16. The non-transitory computer-readable storage medium of claim 12, wherein for retransmission of the PPDU, the STA is configured to preempt the wireless medium by transmission of a reservation signal less than a SIFS after a start of a contention period,
wherein after transmission of the reservation signal, the processing circuitry is to configure the STA to contend for the medium using EDCA parameters for preemption, wherein the EDCA parameters for preemption comprise a shortened backoff, the shortened backoff being less that a backoff for the voice access category.

17. The non-transitory computer-readable storage medium of claim 16, wherein the reservation signal comprises only a preamble comprising a shortened training field signal to trigger symbol detection by other STAs.

18. The non-transitory computer-readable storage medium of claim 12, wherein when the initial transmission of the PPDU is successful or when the retransmission of the PPDU is successful, for subsequent PPDU transmissions the processing circuitry is configured to switch back use of the initial EDCA parameters, and
wherein when the retransmission of the PPDU is unsuccessful using the EDCA parameters for prioritized access, the processing circuitry is configured to utilize the EDCA parameters for prioritized access for subsequent retransmissions of the PPDU.

19. A method performed by processing circuitry of a non-access point station (STA) for transmission of a physical layer protocol data unit (PPDU) to an access point station (AP), the method comprising:
performing an enhanced distributed channel access (EDCA) process to access a wireless medium for an initial transmission of the PPDU based on initial EDCA parameters, the EDCA process comprising determining a random backoff for accessing the medium based on an access category of the PPDU;
wherein if the initial transmission of the PPDU is unsuccessful, for retransmission of the PPDU, the method further comprises:
updating the EDCA parameters to EDCA parameters for prioritized access; and
determining a backoff for accessing the wireless medium and retransmission of the PPDU based on the EDCA parameters for prioritized access,
wherein the EDCA parameters for prioritized access are configured to give the STA a higher probability of accessing the wireless medium for a PPDU retransmission than use of the initial EDCA parameters.

20. The method of claim 19, wherein for the initial transmission of the PPDU, the random backoff is determined to be between zero and a minimum contention window (CWmin), the CWmin based on the access category of the PPDU,
wherein the EDCA process to access the medium for the initial transmission of the PPDU is performed in accordance with one of four access categories comprising, in order from highest to lowest priority: Voice (AC_VO), Video (AC_VI), Best Effort (AC_BE) and Background (AC_BK) access categories, and
wherein to provide the prioritized access, the EDCA parameters for the prioritized access have lower values for one or more of the CWmin and an arbitration inter-frame space number (AIFSN) than the four access categories.
